(19) United States
(12) Patent Application Publication
(10) Pub. No.: US 2009/0313340 A1
(43) Pub. Date: Dec. 17, 2009

(54) DATA PROCESSING SYSTEM AND COMPUTER READABLE MEDIUM

(75) Inventors: Yoshinori ANDO, Kawasaki-shi (JP); Haruhisa HOSHINO, Kawasaki-shi (JP); Takashi MURAKAMI, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/337,680

(22) Filed: Dec. 18, 2008

(30) Foreign Application Priority Data
Jun. 13, 2008 (JP) 2008-155200

(51) Int. Cl. G06F 15/16

(52) U.S. Cl. 709/206

(57) ABSTRACT

A data processing system includes a memory, a position information generation unit, a position information sending unit and an electronic data deletion unit. The memory stores electronic data. The position information generation unit generates position information of the electronic data to acquire the electronic data which is stored in the memory through a communication line. The position information sending unit sends the position information to users of the electronic data through the communication line. The electronic data deletion unit deletes the electronic data from the memory when the electronic data are sent to all of the users to which the position information generated by the position information generation unit is sent.

### CROSS-REFERENCE TO RELATED APPLICATIONS

This application is based on and claims priority under 35 USC 119 from Japanese Patent Application No. 2008-155200 filed Jun. 13, 2008.

### BACKGROUND

This invention relates to a data processing system and a computer readable medium.

### SUMMARY

According to an aspect of the invention, a data processing system includes a memory, a position information generation unit, a position information sending unit and an electronic data deletion unit. The memory stores electronic data. The position information generation unit generates position information of the electronic data to acquire the electronic data which is stored in the memory through a communication line. The position information sending unit sends the position information to users of the electronic data through the communication line. The electronic data deletion unit deletes the electronic data from the memory when the electronic data are sent to all of the users to which the position information generated by the position information generation unit is sent.

### BRIEF DESCRIPTION OF THE DRAWINGS

Exemplary embodiments of the present invention will be described in detail based on the following figures, wherein:

FIG. 1 is a block diagram of electric connection of an image processing apparatus of a first exemplary embodiment of the invention;

FIG. 2 is a flowchart to describe processing of the image processing apparatus of the first exemplary embodiment of the invention;

FIG. 3 is a schematic representation to show an example of the contents of an e-mail;

FIG. 4 is a flowchart to describe processing of the image processing apparatus of the first exemplary embodiment of the invention;

FIG. 5 is a flowchart to describe processing of the image processing apparatus of the first exemplary embodiment of the invention;

FIG. 6 is a flowchart to describe processing of an image processing apparatus of a second exemplary embodiment of the invention;

FIG. 7 is a schematic representation of an already sent e-mail destination table;

FIG. 8 is a schematic representation to show an example of the contents of an e-mail;

FIG. 9 is a flowchart to describe processing of the image processing apparatus of the second exemplary embodiment of the invention;

FIG. 10 is a flowchart to describe processing of the image processing apparatus of the second exemplary embodiment of the invention;

FIG. 11 is a flowchart to describe processing of an image processing apparatus of a third exemplary embodiment of the invention;

FIG. 12 is a schematic representation of an already sent e-mail destination table;

FIG. 13 is a flowchart to describe processing of the image processing apparatus of the third exemplary embodiment of the invention; and

FIG. 14 is a flowchart to describe processing of the image processing apparatus of the third exemplary embodiment of the invention.

### DETAILED DESCRIPTION

Referring now to the accompanying drawings, there are shown exemplary embodiments of the invention.

### First Exemplary Embodiment

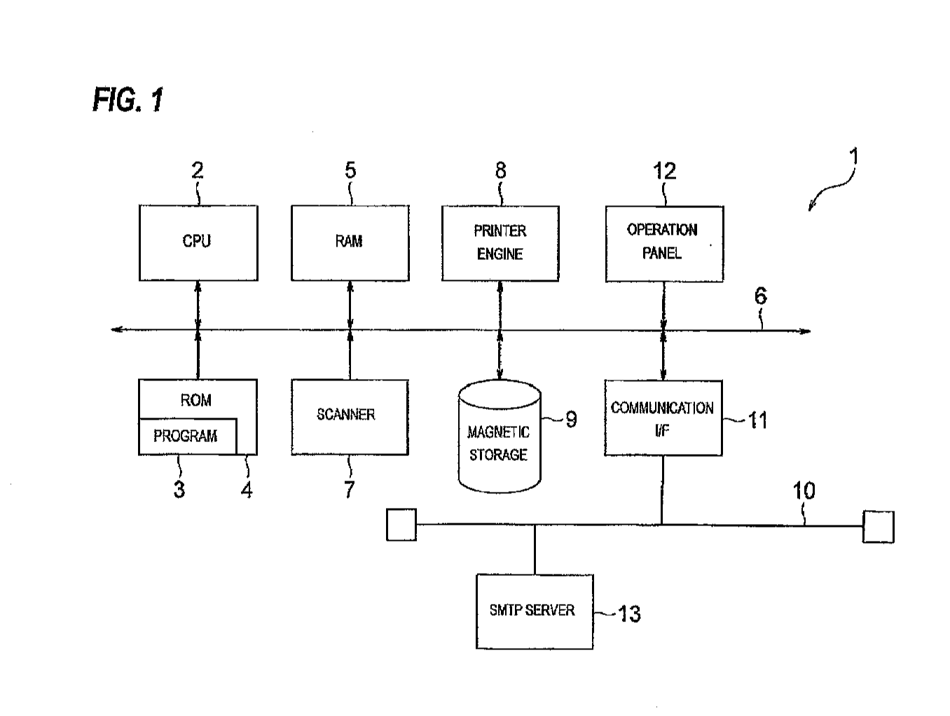

FIG. 1 is a block diagram of electric connection of an image processing apparatus of one exemplary embodiment of the invention. An image processing apparatus 1 is a multifunction device including multiple functions, and has a CPU 2 for controlling the whole of the image processing apparatus 1 in a concentrated manner, ROM 4 storing fixed data and a program 3 used by the CPU 2, and RAM 5 used as a work area of the CPU 2, which are connected by a bus 6.

Connected to the bus 6 are a scanner 7 for reading an image of a document, a printer engine 8 for forming an image on a print medium such as a sheet of paper based on the image data read through the scanner 7, etc., magnetic storage 9 for storing the image data read through the scanner 7, etc., a communication interface (I/F) 11 for communicating with a network 10 of a LAN, the Internet, etc., and an operation panel 12 provided with various keys and a touch panel.

The image processing apparatus 1 also has a function of sending an e-mail through the network 10 and a function as a server for transferring the image data stored in the magnetic storage 9 through the network 10 in response to a data transfer request. In this case, the e-mail is sent through an SMTP server 13 on the network 10.

The image processing apparatus 1 executes various types of processing as described below based on the program 3. The program 3 may be initially stored in the ROM 4 or may be later transmitted to the image processing apparatus 1 in the form of a carrier wave through the communication interface 11 and may be set in nonvolatile memory, etc., implementing the ROM 4.

Next, the processing executed by the image processing apparatus 1 based on the program 3 will be discussed.

To begin with, to allow plural users to view, through the network 10, image data read through the scanner 7 and stored in the magnetic storage 9, it is possible to attach the image data to an e-mail for transmission.

However, since image data generally involves a large data amount, if an attempt is made to send the image data by attaching to the e-mail, the attached image data may be unable to pass through a mail server on the network 10.

Then, the image processing apparatus 1 sends an e-mail writing a URL (Uniform Resource Locator) indicating position information of the image data to acquire the image data to plural users allowed to view the image data.

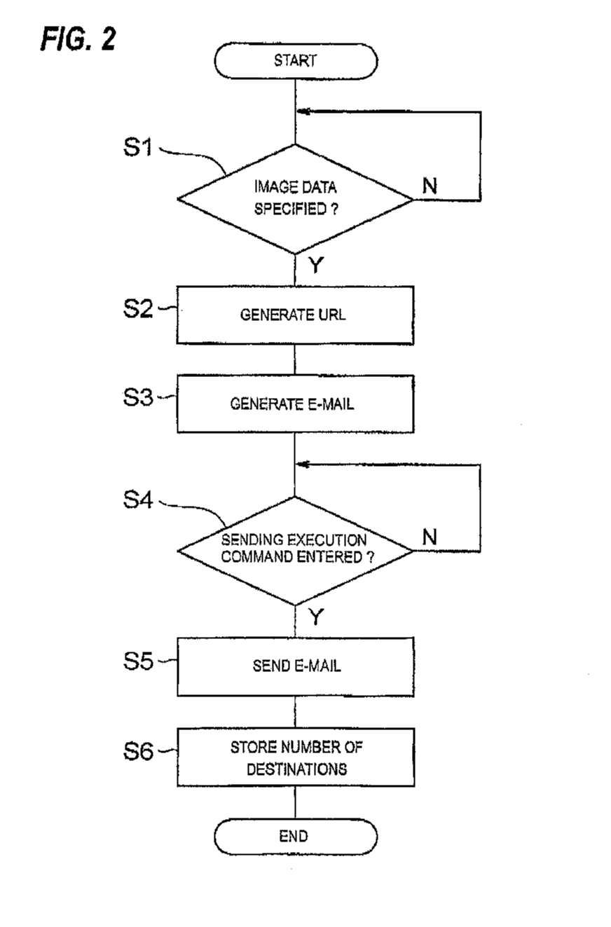

FIG. 2 is a flowchart to describe the processing. That is, when the user specifies, by operating the operation panel 12, (i) the e-mail addresses of the users to whom the image data is to be sent in an address book (not shown) and (ii) the image data stored in the magnetic storage 9 to be provided for the users to view (Y at step $I), the CPU 2 generates a URL indicating the position of the image data on the Web (step S2) and generates an e-mail writing the URL for prompting each of the users to acquire the image data by clicking on the URL (step S3). The contents of the e-mail are displayed on the touch panel of the operation panel 12, etc. When the user enters an execution command of sending the e-mail by operating the operation panel 12 (Y at step S4), the e-mail is sent to the plural users specified at step S1 (step S5) The number of the destinations of the e-mail is stored in an area of nonvolatile memory, etc., (step S6).

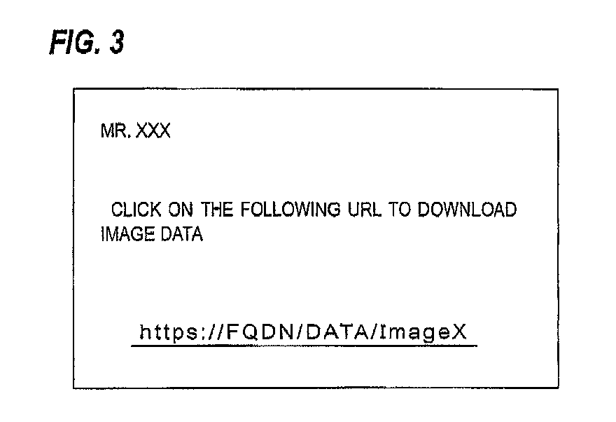

FIG. 3 shows an example of the contents of the e-mail. The URL shown in the example of the contents is “https://” followed by “FQDN/DATA/ImageX”. In the portion of “FQDN/DATA/ImageX,” “FQDN” indicates position information of the image processing apparatus 1 which stores the image data on the Web, “DATA” indicates the magnetic storage 9, and “ImageX” indicates the position of the image data in the magnetic storage 9.

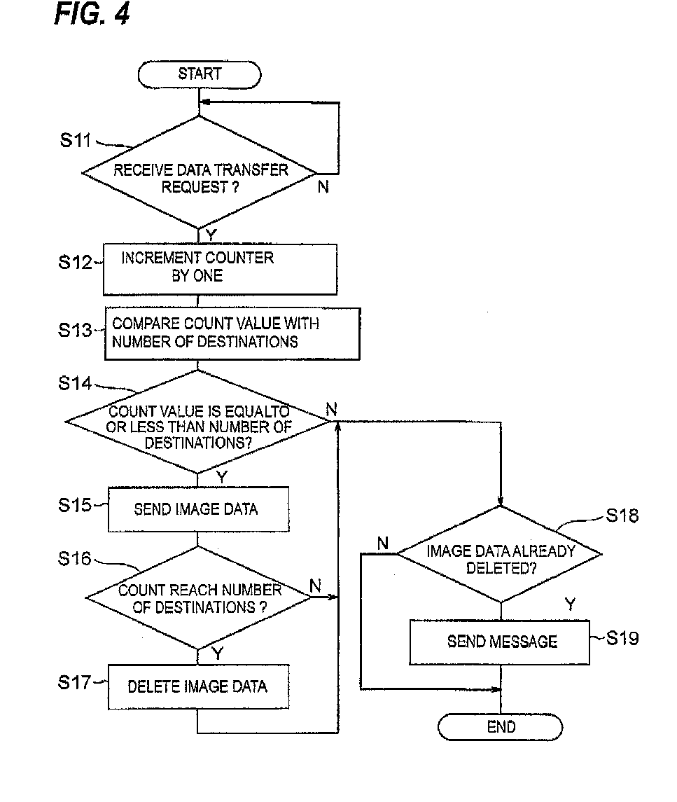

The user receiving the e-mail can display the e-mail on his or her personal computer and can click on the URL, thereby acquiring the image data. FIG. 4 is a flowchart to describe the processing. That is, upon reception of a data transfer request sent by the user clicking on the URL (Y at step S11), the CPU 2 increments a counter for counting the number of the data transfer requests sent by clicking on the same URL as the URL (the counter is stored in an area of nonvolatile memory, etc.,) by one (step S12) and compares the count of the counter with the number of the destinations of the e-mail forming the URL, stored at step S6 (step S13).

When the count of the counter is equal to or less than the number of the destinations of the e-mail (Y at step S14), the image data indicated by the URL is read from the magnetic storage 9 and is sent to the destination (step S15). When the count reaches the number of the destinations of the e-mail (Y at step S16), it is determined that the data transfer request has been received from every user of the destination and the image data has been sent to all the users, and the image data indicated by the URL is deleted (step S17). When the image data indicated by the URL is already deleted (Y at step S18), a message showing the image data cannot be transferred is sent (step S19).

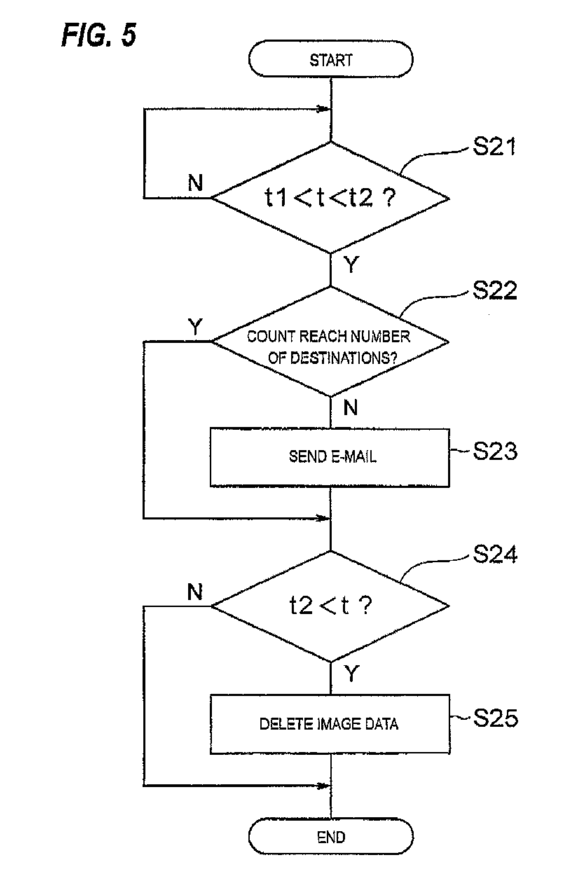

The image data is also deleted after the expiration of a predetermined time. FIG. 5 is a flowchart to describe the processing. That is, the CPU 2 determines an elapsed time t since sending of the e-mail at step S5 according to a clock contained in the system of the image processing apparatus 1. When the CPU 2 determines that the time t exceeds a time t1 although it does not exceed a predetermined time t2 longer than the time t1 (Y at S21), the CPU 2 determines whether or not the above-mentioned count reaches the number of the destinations of the e-mail (step S22). When the count does not reach the number of the destinations, the CPU 2 sends an e-mail of the contents for prompting each user to acquire the image data as quickly as possible if he or she does not yet acquire the image data to all the users to whom the e-mail writing the URL was sent at step S5 (step S23). The CPU 2 determines the elapsed time t since sending of the e-mail at step S5. When the CPU 2 determines that the time t exceeds the predetermined time t2 longer than the time t1 (Y at S24), even if the count of the counter does not reach the number of the destinations of the e-mail and therefore it is determined that some user or users do not yet acquire the image data among the destinations, the CPU 2 deletes the image data in the magnetic storage 9 (step S25).

### Second Exemplary Embodiment

A second exemplary embodiment of the invention will be discussed.

In the first exemplary embodiment of the invention described above, when the received number of the data transfer requests of the image data based on the same URL becomes the same as the number of the destinations to which the e-mail with the URL attached thereto was sent, it is determined that all users of the destinations have acquired the image data indicated by the URL, and the image data is deleted (step S17).

However, the same user of the destination can make a data transfer request of the image data based on the same URL more than once because of erroneous operation or by intention, in which case it is also possible to delete the image data at step S17 although there is a user not acquiring the image data indicated by the URL among the destinations.

In the second exemplary embodiment of the invention, a configuration example indented for making it possible to prevent such a situation will be discussed. To begin with, the hardware configuration of an image processing apparatus 1 is similar to that in the first exemplary embodiment of the invention shown in FIG. 1 and will not be discussed again in detail.

The image processing apparatus 1 sends an e-mail writing a URL of position information of image data to acquire the image data to plural users allowed to view the image data.

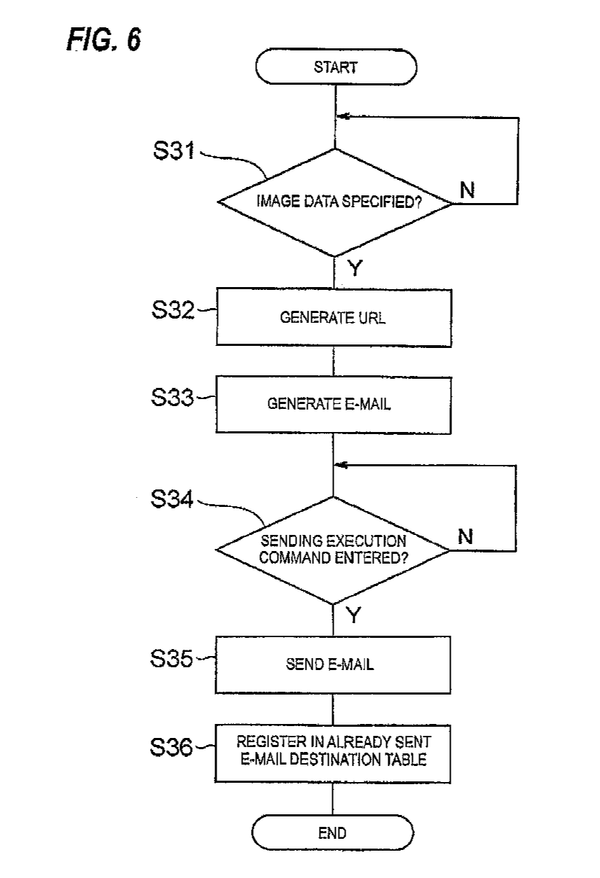

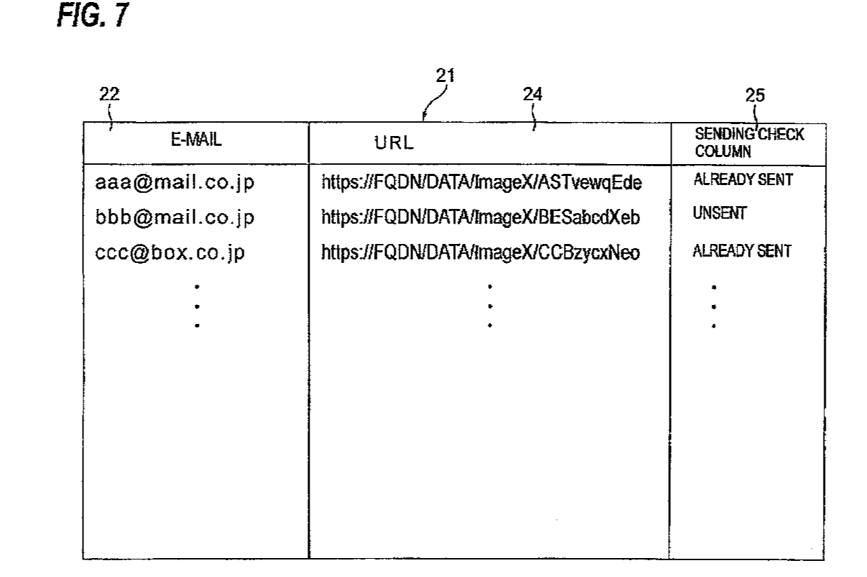

FIG. 6 is a flowchart to describe the processing. That is, when the user specifies the e-mail addresses of the users to whom the image data is to be sent in an address book (not shown) and specifies the image data stored in magnetic storage 9 to be provided for the users to view by operating an operation panel 12 (Y at step S31), a CPU 2 generates plural URLs indicating the position of the image data on the Web (step S32) and generates an e-mail writing each of the URLs for prompting each of the users to acquire the image data by clicking on the corresponding URL (step S33). That is, the URLs sent to the destinations differ and the different URLs are attached to the e-mails to the destinations in a one-to-one correspondence. The contents of the e-mail are displayed on a touch panel of the operation panel 12, etc., (only the contents of one e-mail are displayed as a representative), When the user enters an execution command of sending the e-mail by operating the operation panel 12 (Y at step S34), the e-mail is sent to the plurality of users specified at step S31 (step S35). E-mails 22 and URLs 24 attached to the e-mails are registered in an already sent e-mail destination table 21 shown in FIG. 7 in association with each other (step S36).

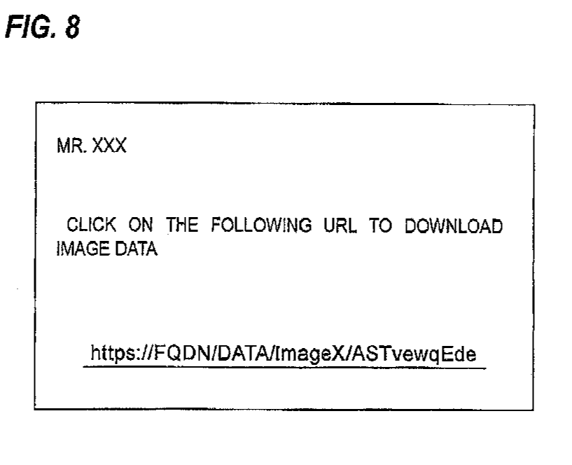

FIG. 8 shows an example of the contents of the e-mail. Each of the URLs shown in the example of the contents is “https://” followed by “FQDN/DATA/ImageX.” In the portion of “FQDN/DATA/ImageX,” “FQDN” indicates position information of the image processing apparatus 1 storing the image data on the Web, “DATA” indicates the magnetic storage 9 storing the image data, and “ImageX” is information for determining the image data in the magnetic storage 9.

“FQDN/DATA/ImageX” is followed by a character string of “ASTvewqEde” in the example, but the character string is not significant and is a character string selected at random. However, different character strings are selected for all destinations to which URLs containing “https://FQDN/DATA/ImageX.” Therefore, the URLS are like “https://FQDN/DATA/ImageX/ASTvewqEde” and differ in the part of “ASTvewqEde” depending On the destination to which the e-mail is to be sent.

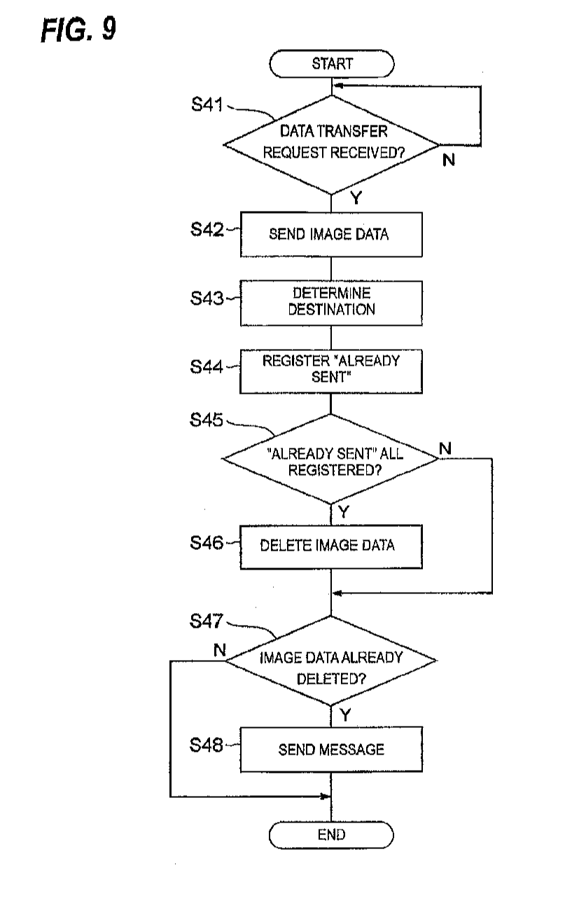

The user receiving the e-mail can display the e-mail on his or her personal computer and can click on the URL, thereby acquiring the image data. FIG. 9 is a flowchart to describe the processing. That is, upon reception of a data transfer request sent by the user clicking on the URL (Y at step $41), the CPU 2 reads the image data corresponding to the URL from the magnetic storage 9 and transmits the image data to the destination (step S42).

The CPU 2 searches the URL 24 of the already sent e-mail destination table 21 shown in FIG. 7 for the different part for each destination receiving the e-mail involving the URL, and determines the destination of the user making the data transfer request according to the URL (step S43). The CPU 2 registers data of already sent in a sending check column 25 stored in the already sent e-mail destination table 21 corresponding to the URL 24 (step S44) to check the destination to which the URL was sent by e-mail, the user making the data transfer request of the image data.

When the data of already sent is all registered in the sending check column 25 corresponding to the URLs 24 of all the users of the destinations to which the URL was sent by e-mail at step S44 (Y at step S45), it is determined that the data transfer request has been received from every user of the destination and the image data has been sent to all the users, and the image data indicated by the URL is deleted (step S46). When the image data indicated by the URL is already deleted (Y at step S47), a message to the effect that the image data cannot be transferred is sent (step S48).

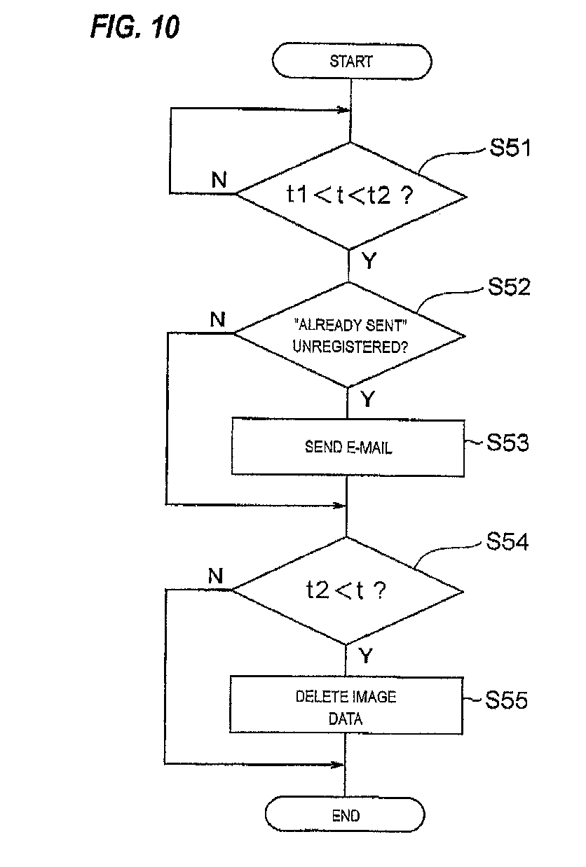

The image data is also deleted after the expiration of a predetermined time. FIG. 10 is a flowchart to describe the processing. That is, the CPU 2 determines an elapsed time t since sending of the e-mail at step S35 according to a clock contained in the system of the image processing apparatus 1. When the CPU 2 determines that the time t exceeds a time t1 although it does not exceed a predetermined time t2 longer than the time t1 (Y at S51), the CPU 2 references the already sent e-mail destination table 21 and determines whether or not there is a destination with the data of already sent not registered in the sending check column 25 (step S52) When there is a destination with the data of already sent not registered in the sending check column 25, the CPU 2 sends an e-mail of the contents for prompting the user to acquire the image data as quickly as possible because he or she does not yet acquire the image data to the destination (step S53). The CPU 2 determines the elapsed time t since sending of the e-mail at step S35. When the CPU 2 determines that the time t exceeds the predetermined time t2 longer than the time t1 (Y at S54), even if the CPU 2 references the already sent e-mail destination table 21 and determines that there is a destination with the data of already sent not registered in the sending check column 25 and therefore determines that some user or users do not yet acquire the image data among the destinations, the CPU 2 deletes the image data in the magnetic storage 9 (step S55).

### Third Exemplary Embodiment

A third exemplary embodiment of the invention will be discussed.

In the second exemplary embodiment of the invention, the already sent e-mail destination table 21 is used. However, since e-mails 22 and URLs 24 are registered in the already sent e-mail destination table 21 in association with each other, if the number of destinations allowed to acquire image data is large, a large storage capacity is required for storing the already sent e-mail destination table 21.

Then, an example wherein the storage capacity of the already sent e-mail destination table 21 can be decreased will be discussed as the third exemplary embodiment of the invention. To begin with, the hardware configuration of an image processing apparatus 1 is similar to that in the first exemplary embodiment of the invention and will not be discussed again in detail.

The image processing apparatus 1 also sends an e-mail writing a URL of position information of image data to acquire the image data to plural users allowed to view the image data.

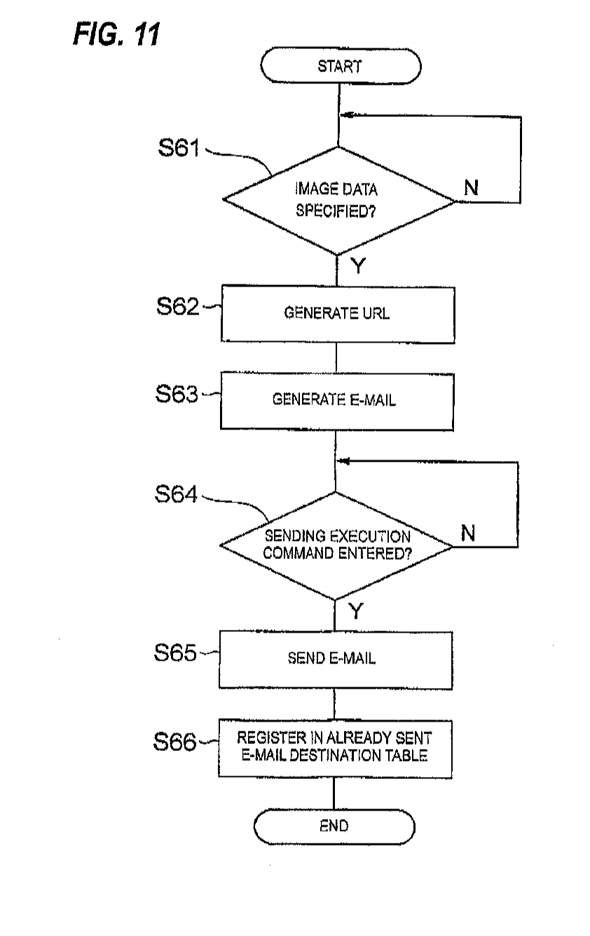

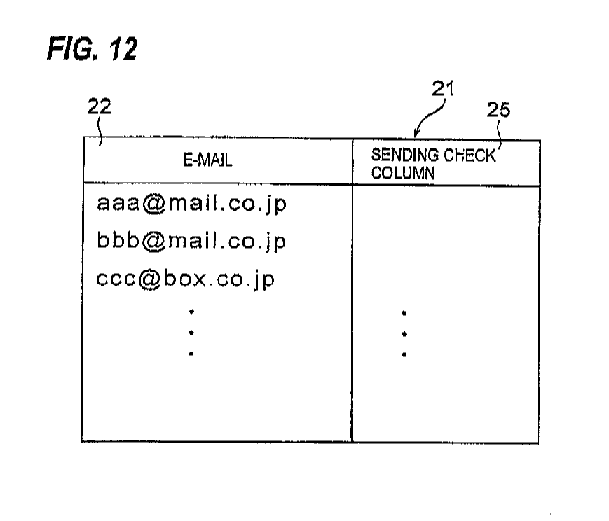

FIG. 11 is a flowchart to describe the processing, That is, when the user specifies the e-mail addresses of the users to whom the image data is to be sent in an address book (not shown) and specifies the image data stored in magnetic storage 9 to be provided for the users to view by operating an operation panel 12 (Y at step S61), a CPU 2 generates plural URLs indicating the position of the image data on the Web (step S62) and generates an e-mail writing each of the URLs for prompting each of the users to acquire the image data by clicking on the corresponding URL (step S63). That is, the URLs sent to the destinations differ and the different URLs are attached to the e-mails to the destinations in a one-to-one correspondence. The contents of the e-mail are displayed on a touch panel of the operation panel 12, etc., (only the contents of one e-mail are displayed as a representative). When the user enters an execution command of sending the e-mail by operating the operation panel 12 (Y at step S64), the e-mail is sent to the plurality of users specified at step S31 (step S65). E-mails 22 and destination names 23 of the e-mails are registered in an already sent e-mail destination table 21 shown in FIG. 12 (step S66). This already sent e-mail destination table 21 is made simpler than that shown above in FIG. 7; the e-mails and a sending check column 25 are associated with each other for registration and a URL 24 as shown in FIG. 7 is not registered.

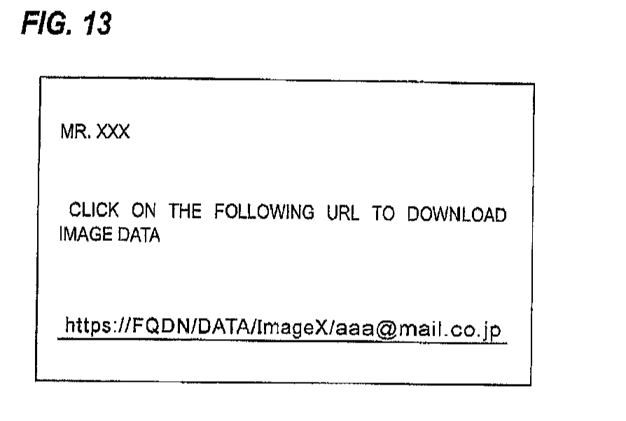

FIG. 13 shows an example of the contents of the e-mail. Each of the URLs shown in the example of the contents is “https://” followed by “FQDN.” “FQDN” indicates position information of the image processing apparatus 1 storing the image data on the Web.

The “FQDN” part is followed by a character string of “ASTvewqEde” in the example. The “ASTvewqEde” part is provided by coding a predetermined character string according to a predetermined system. That is, the portion of “DATA/ImageX” of “FQDN/DATA/ImageX” and the e-mail address of the destination of the e-mail (in the example, “aaa@mail.co.jp”) are concatenated into “DATA/ImageX/aaa@mail.co.jp,” which is coded according to the predetermined system to provide the character string of “ASTvewqEde.”

“DATA” indicates the magnetic storage 9 storing the image data, and “ImageX” is information for determining the image data in the magnetic storage 9.

As the coding system, a coding system for enabling the image processing apparatus 1 to perform easy decoding, for example, Base64 can be used. Since the portion of the e-mail address varies from one destination of the e-mail to another, the character string provided by coding also varies from one destination of the e-mail to another.

The user receiving the e-mail can display the e-mail on his or her personal computer and can click on the URL, thereby acquiring the image data. FIG. 13 is a flowchart to describe the processing. That is, upon reception of a data transfer request sent by the user clicking on the URL (Y at step S71), the CPU 2 decodes the character string provided by coding the URL (step S72). That is, the URL provided by decoding the character string is “https://FQDN/DATA/ImageX/aaa@mail.co.jp” and thus the CPU 2 reads the image data specified by “DATA/ImageX” from the magnetic storage 9 and transmits the image data to the destination (step S73).

The CPU 2 searches the e-mails 22 of the already sent e-mail destination table 21 shown in FIG. 12 for the e-mail contained in the URL provided by decoding, and determines the destination of the user making the data transfer request (step S74). The CPU 2 registers data of already sent in the sending check column 25 stored in the already sent e-mail destination table 21 corresponding to the e-mail 22 (step S75) to check the destination to which the e-mail with the URL written therein was sent, the user making the data transfer request of the image data.

When the data of already sent is all registered in the sending check column 25 corresponding to the e-mails 22 of all the users of the destinations to which the URL was sent by e-mail at step S75 (Y at step S76), it is determined that the data transfer request has been received from every user of the destination and the image data has been sent to all the users, and the image data indicated by the URL is deleted (step S78). When the image data indicated by the URL is already deleted (Y at step S77), a message to the effect that the image data cannot be transferred is sent (step S79).

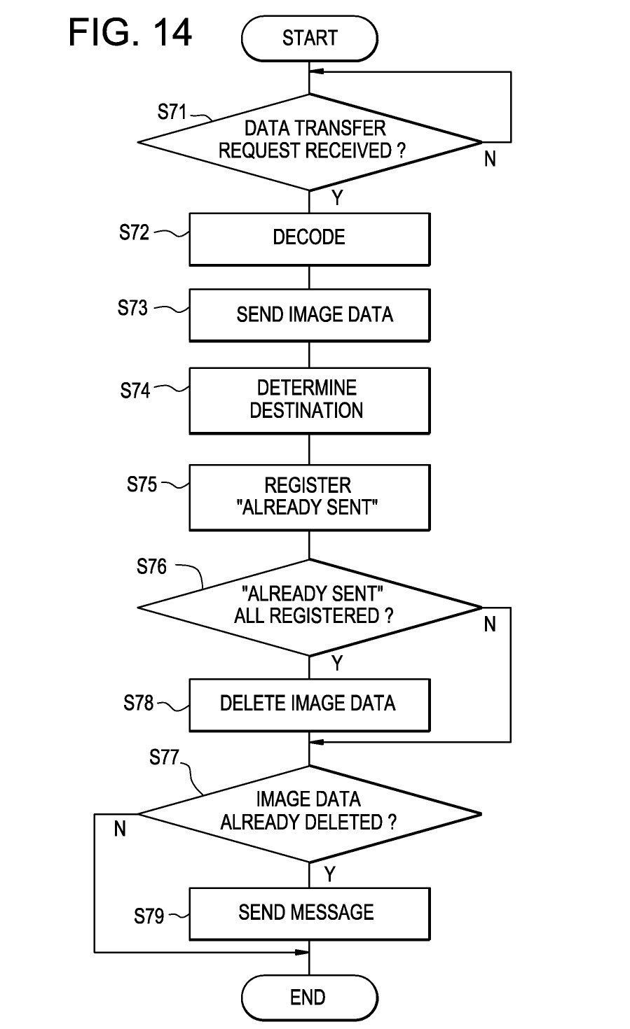

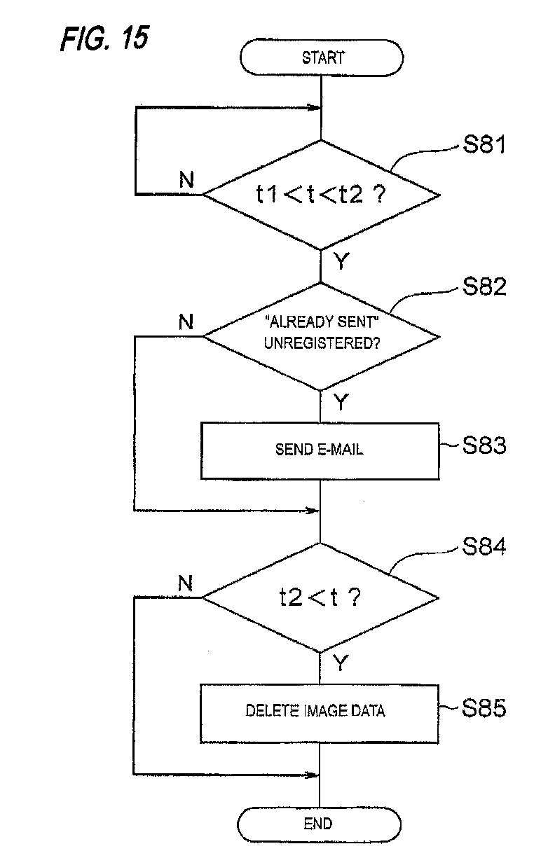

The image data is also deleted after the expiration of a predetermined time. FIG. 14 is a flowchart to describe the processing. That is, the CPU 2 determines an elapsed time t since sending of the e-mail at step S65 according to a clock contained in the system of the image processing apparatus 1. When the CPU 2 determines that the time t exceeds a time t1 although it does not exceed a predetermined time t2 longer than the time t1 (Y at S81), the CPU 2 references the already sent e-mail destination table 21 and determines whether or not there is a destination with the data of already sent not registered in the sending check column 25 (step S82). When there is a destination with the data of already sent not registered in the sending check column 25, the CPU 2 sends an e-mail of the contents for prompting the user to acquire the image data as quickly as possible because he or she does not yet acquire the image data to the destination (step S83). The CPU 2 determines the elapsed time t since sending of the e-mail at step S65. When the CPU 2 determines that the time t exceeds the predetermined time t2 longer than the time t1 (Y at S84), even if the CPU 2 references the already sent e-mail destination table 21 and determines that there is a destination with the data of already sent not registered in the sending check column 25 and therefore determines that some user or users do not yet acquire the image data among the destinations, the CPU 2 deletes the image data in the magnetic storage 9 (step S85).

In the third exemplary embodiment of the invention, the URL containing the e-mail address of the destination is coded according to the predetermined coding system before it is sent, but the URL containing the e-mail address of the destination may be written directly to the e-mail before it is sent without performing such coding. However, from the viewpoint of information security, it is desirable that the URL containing the e-mail address of the destination should be coded before it is sent.

The image processing apparatus 1 is implemented as a copier including multiple functions, but may be implemented as a general server computer on the Web, etc. In this case, a server for sending e-mail and a server for storing image data may be different apparatus.

Further, the data stored in the magnetic storage 9 is image data in the example described above, but may be various types of electronic data, such as data created by an application of a personal computer.

In addition, e-mail need not necessarily be sent to plural destinations and may be sent to a single destination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing system comprising:
a memory that stores electronic data;
a position information generation unit that generates position information of the electronic data to acquire the electronic data which is stored in the memory through a communication line;
a position information sending unit that sends the position information to users of the electronic data through the communication line; and
an electronic data deletion unit that deletes the electronic data from the memory when the electronic data are sent to all of the users to which the position information generated by the position information generation unit is sent.

2. A data processing system comprising;
a memory that stores electronic data;
a position information generation unit that generates position information of the electronic data to acquire the electronic data stored in the memory communication line;
a position information sending that sends the position information to users of the electronic data through the communication line;
a sending determination unit that determines whether or not the electronic data is sent to all of the users to which the position information generated in the position information generation unit is sent; and
an electronic data deletion unit that deletes, when the sending determination unit determines that the electronic data is sent to all of the users, the electronic data from the memory.

3. The data processing system according to claim 2, further comprising:
an informing unit that sends, when the sending determination unit determines that the electronic data is not sent to all of the users by the time a first preset time elapses, information to at least a user that does not acquires the electronic data,
wherein the information indicates information prompting the user to acquire the electronic data.

4. The data processing system according to claim 3,
wherein the electronic data deletion unit deletes, when the sending determination unit determines that the electronic data is not sent to all of the users to which the position information of the electronic data is sent by the time a second preset time expires after the first preset time elapses, deletes the electronic data from the memory.

5. The data processing system according to claim 2
wherein the sending determination unit comprises:
a count unit that counts the number of times of sending the electronic data in response to a transfer request of sending the electronic data, the transfer request being sent based on the piece of position information through the communication line; and
a number-of-times determination unit that determines that, when the number of times counted by the count unit reaches the number of the users acquiring the electronic data, the electronic data is sent to all of the users to which the position information is sent.

6. The data processing system according to claims 2,
wherein the position information generation unit generates transfer requests as many as the number of users acquiring the electronic data through the communication line,
each piece of transfer request information indicates a transfer request of the electronic data through the communication line,
each piece of transfer request information contains the corresponding piece of position information,
the transfer requests are different from each other, and
the position information sending unit respectively sends the transfer requests to the users acquiring the electronic data through the communication line, and
the sending determination unit comprises:
a transfer request determination unit, when (i) the transfer request of the electronic data based on each piece of transfer request information is received through the communication line and (ii) the electronic data is sent to a requestor of the electronic data, that determines whether the transfer requests of the electronic data based on all transfer requests sent by the position information sending unit are received or not; and
an all-user sending determination unit that determines, when the transfer request determination unit determines that the transfer requests of the electronic data based on all transfer requests sent the position information sending unit are received, the electronic data is sent to all of the users to which the position information is sent.

7. The data processing system according to claim 6,
wherein the position information generation unit generates the transfer requests each containing (i) the position information and (ii) a piece of identification information that specifies the user to which the transfer request information is to be sent by the position information sending unit.

8. The data processing system according to claim 7, further comprising;
a destination information registration unit that registers each identification information and a corresponding piece of destination information in association with each other,
wherein the piece of destination information that indicates the user to which the transfer request information is to be sent, specified by the identification information.

9. The data processing system according to claim 7,
wherein the position information generation unit uses as each identification information, a piece of destination information indicating the user to which the transfer request information is to be sent.

10. The data processing system according to claim 9,
wherein the position information generation unit converts information containing the piece of position information and the piece of identification information into a decodable code as the transfer request information.

11. A computer readable medium storing a program causing a computer to execute a process for data processing, the process comprising:
storing electronic data in a memory;
generating position information of the electronic data to acquire the electronic data stored in the memory through a communication line;
sending the position information to users of the electronic data through the communication line; and
deleting the electronic data from the memory when the electronic data are sent to all of the users to which the generated position information is sent.

12. A computer readable medium storing a program causing a computer to execute a process for data processing, the process comprising:
storing electronic data in a memory;
generating position information of the electronic data to acquire the electronic data stored in the memory through communication line;
sending the position information to users of the electronic data through the communication line;
determining whether the electronic data is sent to all of the users to which the generated position information is sent or not; and
deleting the electronic data from the memory when determining that the electronic data is sent to all of the users.

13. The computer readable medium according to claim 12, the process further comprising:
sending, when determining that the electronic data is not sent to all of the users by the time a first preset time elapses, information to at least a user that does not acquires the electronic data,
wherein the information indicates information prompting the user to acquire the electronic data.

14. The computer readable medium according to claim 13,
wherein deleting the electronic data includes deleting, when determining that the electronic data is not sent to all of the users to which the position information of the electronic data is sent by the time a second preset time expires after the first preset time elapses, the electronic data from the memory.

15. The computer readable medium according to claim 12, the process further comprising;
counting the number of times of sending the electronic data in response to a transfer request of sending the electronic data, the transfer request being sent based on the piece of position information through the communication line; and
determining, when the counted number of times reaches the number of the users acquiring the electronic data, the electronic data is sent to all of the users to which the position information is sent.

16. The computer readable medium according to claim 12,
wherein generating the position information further includes generating transfer requests as many as the number of users acquiring the electronic data through the communication line,
each piece of transfer request information indicates a transfer request of the electronic data through the communication line,
each piece of transfer request information contains the corresponding piece of position information,
the transfer requests are different from each other, and
sending the position information further includes respectively sending the transfer requests to the users acquiring the electronic data through the communication line, and
the process further comprising;
determining, when (i) the transfer request of the electronic data based on each piece of transfer request information is received through the communication line and (ii) the electronic data is sent to a request or of the electronic data, whether the transfer requests of the electronic data based on all of the sent transfer requests are received or not; and
determining, when determining that the transfer requests of the electronic data based on all of the sent transfer requests are received, the electronic data is sent to all of the users to which the position information is sent.

17. The computer readable medium according to claim 16,
wherein generating the position information further includes generating the transfer requests each containing (i) the position information and (ii) a identification information that specifies the user to which the transfer request information is to be sent.

18. The computer readable medium according to claim 17, the process further comprising:
registering each identification information and a corresponding piece of destination information in association with each other,
wherein the piece of destination information that indicates the user to which the transfer request information is to be sent, specified by the identification information.

19. A data processing system comprising:
a memory that stores electronic data; and
an electronic data deletion unit that deletes the electronic data from the memory when the electronic data is sent to all of users to which position information sent to the users of the electronic data through communication line is sent.

20. A data processing system comprising;
a memory that stores electronic data;
a sending determination unit that determines whether or not the electronic data is sent to all users to which position information sent to the users of the electronic data through communication line is sent; and
an electronic data deletion unit that deletes the electronic data from the memory when the sending determination unit determines that the electronic data is sent to all users.

21. The data processing system according to claim 20, further comprising;
an informing unit that sends, when the sending determination unit determines that the electronic data is not sent to all of the users by the time a first preset time elapses, information to at least a user that does not acquires the electronic data,
wherein the information indicates information prompting the user to acquire the electronic data.

22. The data processing system according to claim 21,
wherein the electronic data deletion unit deletes, when the sending determination unit determines that the electronic data is not sent to all of the users to which the position information of the electronic data is sent by the time a second preset time expires after the first preset time elapses, deletes the electronic data from the memory.

23. A computer readable medium storing a program causing a computer to execute a process for data processing, the process comprising:
storing electronic data in a memory; and
deleting the electronic data from the memory when the electronic data is sent to all of users to which position information sent to the users of the electronic data through communication line is sent.

24. A computer readable medium storing a program causing a computer to execute a process for data processing, the process comprising:
storing electronic data in a memory;
determining whether or not the electronic data is sent to all users to which position information sent to the users of the electronic data through communication line is sent; and
deleting the electronic data from the memory when determining that the electronic data is sent to all users.

25. The computer readable medium according to claim 24, further comprising:
sending, when determining that the electronic data is not sent to all of the users by the time a first preset time elapses, information to at least a user that does not acquires the electronic data,
wherein the information indicates information prompting the user to acquire the electronic data.

26. The computer readable medium according to claim 25,
wherein the electronic data deletion unit deletes, when the sending determination unit determines that the electronic data is not sent to all of the users to which the position information of the electronic data is sent by the time a second preset time expires after the first preset time elapses, deletes the electronic data from the memory.
